(19) United States
(12) Patent Application Publication
(10) Pub. No.: US 2026/0080172 A1
(43) Pub. Date: Mar. 19, 2026

(54) METHOD AND SYSTEM FOR DOCUMENT CHUNKING

(71) Applicant: SAMSUNG SDS CO., LTD., Seoul (KR)

(72) Inventors: Sung Hak SONG, Seoul (KR); Su In Yoon, Seoul (KR); A Young Jung, Seoul (KR); Jin Hyuk Kim, Seoul (KR)

(73) Assignee: SAMSUNG SDS CO., LTD., Seoul (KR)

(21) Appl. No.: 19/230,785

(22) Filed: Jun. 6, 2025

(30) Foreign Application Priority Data
Sep. 13, 2024 (KR) 10-2024-0126115
Mar. 14, 2025 (KR) 10-2025-0033211

(51) Int. Cl. G06F 40/289; G06F 16/93; G06F 40/177

(52) U.S. Cl. CPC G06F 40/289; G06F 16/93; G06F 40/177

(57) ABSTRACT

A method and system for chunking a document are provided. The method according to some embodiments may include chunking a document including a plurality of sentences into a plurality of section chunks based on sentences including a section delimiter, determining whether a size of each of the plurality of section chunks exceeds a preset first threshold and chunking a section chunk, a size of the section chunk among the plurality of section chunks exceeds the preset first threshold, into a plurality of sub-chunks based on whether a similarity between sentences included in the section chunk is equal to or greater than a second threshold. The second threshold may be determined based on a similarity distribution of a query for the document, calculated by comparing a query generated from the document using a generative model with the document.

### CROSS-REFERENCE TO RELATED APPLICATION(S)

This application claims priority from Korean Patent Application No. 10-2024-0126115 filed on Sep. 13, 2024, and Korean Patent Application No. 10-2025-0033211 filed on Mar. 14, 2025, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for document chunking, and more specifically, to a semantic chunking method that chunks a document in consideration of context, and a system for performing the same.

### 2. Description of the Related Art

Question-answering is a task in the field of natural language processing for generating responses to queries written in natural language, and research is actively being conducted on methods for generating responses to queries using large language models (LLMs).

Recently, language models employing Retrieval-Augmented Generation (RAG) techniques have been introduced to generate accurate responses to queries. RAG-based language models retrieve documents related to a query from an external database and generate responses using the retrieved documents, thereby overcoming the limitations of conventional models that rely only on pre-trained knowledge.

However, since documents stored in external databases are generally chunked and stored in fixed units without consideration of context. As a result, sentences containing correct answers to queries may be lost or damaged during the chunking process, and the accuracy of generated responses may be reduced due to the low accuracy of retrieval.

Accordingly, there is a need for a new solution to address these issues in document chunking.

### SUMMARY

One objective of the present disclosure is to provide a method for chunking a document in consideration of the structure and context of the document, and a computing system for performing the method.

Another objective of the present disclosure is to provide a method for constructing semantic chunks in context by comparing similarities between sentences in an accumulative manner, and a computing system for performing the method.

Another objective of the present disclosure is to provide a method for reducing the frequency of invoking an embedding model and decreasing the total processing time required for document chunking by performing, in a combined manner, a first chunking process based on the structure of documents and a second chunking process based on the similarity between sentences, and a computing system for performing the method.

Another objective of the present disclosure is to provide a computing system for improving the accuracy of retrieved chunks and responses generated using the retrieved chunks by determining a threshold for sentence similarity through vector similarity analysis between a document and multiple queries generated from the document by a generative model, such that when a chunk related to a particular query is retrieved from a document that has been chunked, the accuracy of the retrieved chunk is improved.

Another objective of the present disclosure is to provide a method for chunking a document including various types of data such as text and tables, and a computing system for performing the method.

Another objective of the present disclosure is to provide a method for training a chunk model that chunks an input document to construct semantic chunks, using documents that have been chunked in units of chunks based on the structure and context of the documents, and a computing system for performing the method.

The objectives of the present disclosure are not limited to those mentioned above, and other objectives not explicitly stated will be clearly understood by those skilled in the art based on the following description.

According to an aspect of the present disclosure, there is provided a method for chunking a document performed by a computing system. The method may include chunking a document including a plurality of sentences into a plurality of section chunks based on sentences including a section delimiter, determining whether a size of each of the plurality of section chunks exceeds a preset first threshold and when a size of a section chunk among the plurality of section chunks exceeds the preset first threshold, chunking the section chunk into a plurality of sub-chunks based on whether a similarity between sentences included in the section chunk is equal to or greater than a second threshold, wherein the second threshold may be determined based on a similarity distribution of a query for the document, calculated by comparing a query generated from the document using a generative model with the document.

In some embodiments, wherein the chunking of the document into the plurality of section chunks may include identifying a plurality of predefined section candidates included in the document by traversing the document in a certain direction and determining a portion of the plurality of predefined section candidates as the section delimiter using at least one of a number of occurrences of each of the plurality of predefined section candidates in the document, a text size of a sentence including each of the plurality of section candidates, or an identification order of each of the plurality of predefined section candidates in the document.

In some embodiments, wherein the determining of the portion of the plurality of predefined section candidates as the section delimiter may include determining a section candidate with a smallest number of occurrences among the plurality of predefined section candidates as the section delimiter.

In some embodiments, wherein the determining of the portion of the plurality of predefined section candidates as the section delimiter may include determining a section candidate whose sentence has a largest text size among the plurality of sentences included in the document as the section delimiter.

In some embodiments, wherein the determining of the portion of the plurality of predefined section candidates as the section delimiter may include when a number of occurrences of a first section candidate is smaller than a number of occurrences of a second section candidate, and a size of a first chunk is greater than a size of a second chunk, determining the first section candidate as the section delimiter, the first chunk may be a largest chunk among chunks configured by chunking the document based on the first section candidate, and the second chunk may be a largest chunk among chunks configured by chunking the document based on the second section candidate.

In some embodiments, wherein the first section candidate may not be determined as the section delimiter when an identification order of the first section candidate is later than an identification order of the second section candidate.

In some embodiments, wherein the chunking of the section chunk into the plurality of sub-chunks may include when an embedding vector similarity between a first sentence and a second sentence included in the section chunk is equal to or greater than the second threshold, configuring a first sub-chunk including the first and second sentences, when the embedding vector similarity between the first and second sentences is less than the second threshold, configuring a second sub-chunk including the first sentence and configuring a third sub-chunk that is different from the second sub-chunk and includes the second sentence, when the embedding vector similarity between a sub-chunk including the second sentence and a third sentence is equal to or greater than the second threshold, configuring a fourth sub-chunk by merging a sub-chunk including the second sentence with the third sentence and when the embedding vector similarity between the sub-chunk including the second sentence and the third sentence is less than the second threshold, configuring a fifth sub-chunk that is different from the sub-chunk including the second sentence and includes the third sentence, the second sentence may be a sentence identified in subsequent order to the first sentence within the section chunk, and the third sentence may be a sentence identified in subsequent order to the second sentence within the section chunk.

In some embodiments, wherein the configuring of the fourth sub-chunk may include when a size of the fourth sub-chunk exceeds a preset third threshold, extracting a keyword from the fourth sub-chunk using a text rank algorithm and chunking the fourth sub-chunk into a plurality of sub-chunks using a distribution of the keyword within the fourth sub-chunk.

In some embodiments, wherein the chunking of the section chunk into the plurality of sub-chunks may include configuring a plurality of sub-documents by chunking the document into preset fixed-size units, inputting the plurality of sub-documents into the generative model and generating a plurality of query-response pairs respectively corresponding to the plurality of sub-documents using output of the generative model, and for each of the plurality of sub-documents, calculating a first embedding vector similarity distribution of a first query for a first sub-document set, wherein the first query corresponds to a first sub-document, and the first sub-document set includes combinations of the plurality of sub-documents including the first sub-document, and calculating a second embedding vector similarity distribution of the first query for a second sub-document set, wherein the second sub-document set includes combinations of the plurality of sub-documents excluding the first sub-document, and the second threshold may be calculated using a deviation between a minimum value of the first embedding vector similarity distribution and a maximum value of the second embedding vector similarity distribution for the plurality of sub-documents.

In some embodiments, the method may further include training a chunking model using the document chunked in units of chunks, wherein the chunking model may be a model pre-trained to receive an input document and chunk the input document into a plurality of chunks.

According to another aspect of the present disclosure, there is provided a method for chunking a document performed by a computing system. The method may include identifying a plurality of sentences by traversing a document including a table in a certain direction from the table and configuring a chunk including the table and one or more sentences among the plurality of identified sentences whose similarity with the table is equal to or greater than a preset first threshold.

In some embodiments, wherein the configuring of the chunk may include configuring a plurality of chunks by chunking the document, the plurality of chunks including a first chunk including the table and a second chunk including the plurality of sentences and when a similarity between the table and a first sentence among the plurality of sentences is equal to or greater than the preset first threshold, merging the first sentence into the first chunk.

According to yet another aspect of the present disclosure, there is provided a method for chunking a document performed by a computing system. The method may inputting a document including a plurality of sentences into a pre-trained chunking include model, configuring a plurality of different chunks each including a portion of the plurality of sentences using information output from the chunking model and storing embedding vectors corresponding to the respective chunks, wherein the plurality of different chunks may include a section chunk and a plurality of sub-chunks, wherein the section chunk being a first section chunk whose size is less than or equal to a preset first threshold among a plurality of section chunks configured by chunking the document based on sentences including a section delimiter among the plurality of sentences, wherein the plurality of sub-chunks may be configured by chunking a second section chunk, whose size exceeds the preset first threshold among the plurality of section chunks, based on whether a similarity between sentences included in the second section chunk is equal to or greater than a preset second threshold, and wherein the preset second threshold may be determined based on a similarity distribution of a query for the document, calculated by comparing a query generated from the document using a generative model with the document.

According to yet another aspect of the present disclosure, there is provided a system for chunking a document. The system may include at least one processor, and at least one memory storing instructions which, when executed by the at least one processor, cause the at least one processor to perform operations, wherein the operations may include chunking a document including a plurality of sentences into a plurality of section chunks based on sentences including a section delimiter, determining whether a size of each of the plurality of section chunks exceeds a preset first threshold and when a size of a section chunk among the plurality of section chunks exceeds the preset first threshold, chunking the section chunk into a plurality of sub-chunks based on whether a similarity between sentences included in the section chunk is equal to or greater than a second threshold, wherein the second threshold may be determined based on a similarity distribution of a query for the document, calculated by comparing a query generated from the document using a generative model with the document.

According to yet another aspect of the present disclosure, there is provided a system for chunking a document. The system may include at least one processor, and at least one memory storing instructions which, when executed by the at least one processor, cause the at least one processor to perform operations, wherein the operations may include identifying a plurality of sentences by traversing a document including a table in a certain direction from the table and configuring a chunk including the table and one or more sentences among the plurality of identified sentences whose similarity with the table is equal to or greater than a preset first threshold.

### BRIEF DESCRIPTION OF THE DRAWINGS

The above and other aspects and features of the present disclosure will become more apparent by describing exemplary embodiments thereof in detail with reference to the attached drawings, in which:

FIG. 1 illustrates an exemplary chunking system according to an embodiment of the present disclosure;

FIG. 2 illustrates a flow of operations of a chunking system according to some embodiments of the present disclosure;

FIG. 3 is a flowchart illustrating an exemplary method for chunking a document including a plurality of sentences according to an embodiment of the present disclosure;

FIGS. 4 and 5 are flowcharts illustrating an exemplary method for determining section delimiters according to some embodiments of the present disclosure;

FIG. 6 is a flowchart illustrating an exemplary method for chunking a document in consideration of context by comparing similarities between sentences in an accumulative manner according to some embodiments of the present disclosure;

FIG. 7 is a diagram for explaining a process for constructing sub-chunks in an accumulative manner according to some embodiments of the present disclosure;

FIG. 8 is a flowchart illustrating an exemplary method for determining a threshold for sentence similarity according to some embodiments of the present disclosure;

FIG. 9 illustrates exemplary chunks constructed by chunking text-type data included in a document according to some embodiments of the present disclosure;

FIG. 10 is a flowchart illustrating an exemplary method for chunking a document including a table according to an embodiment of the present disclosure;

FIG. 11 is a diagram for explaining a process for constructing a table chunk according to some embodiments of the present disclosure;

FIG. 12 illustrates an exemplary chunked document according to some embodiments of the present disclosure; and

FIG. 13 is a block diagram illustrating an exemplary computing device for performing some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

The terms used in the present disclosure are merely for describing specific embodiments and are not intended to limit the features, components, or sequences described in the specification. The terms “comprises” and/or “comprising” as used in the present disclosure indicate the presence of the features, components, steps, operations, and/or combinations thereof described in the specification, but do not preclude the presence or addition of one or more other features, components, steps, operations, and/or combinations thereof.

In addition, in describing the component of the present disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

In the present disclosure, “/” and “,” should be interpreted as representing “and/or.” For example, “A/B” and “A, B” may mean “A and/or B.”

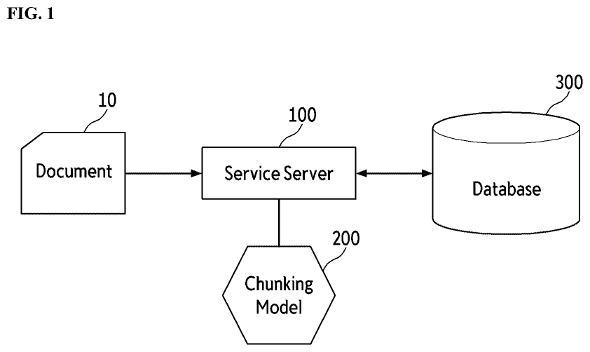

FIG. 1 illustrates an exemplary chunking system according to an embodiment of the present disclosure.

Referring to FIG. 1, the chunking system according to an embodiment of the present disclosure may provide a framework for chunking a document 10 into a plurality of chunks.

Chunking the document 10 refers to dividing the document 10 into chunks, and each of the chunks may include a portion of the data included in the document 10. For example, each of the chunks obtained by chunking the document 10 may include a portion of a sentence, paragraph, or table included in the document 10.

The document 10 may include various types of data such as text and tables. According to some embodiments of the present disclosure, text-type data and table-type data included in the document 10 may be included in separate chunks, or may be included in the same chunk.

Referring to FIG. 1, the chunking system according to an embodiment of the present disclosure may include a service server 100, a chunking model 200, and/or a database 300.

The service server 100 may refer to a computing device or system for chunking the document 10 by performing methods and/or operations according to some embodiments of the present disclosure.

The service server 100 may perform a two-step chunking process by chunking the document 10 based on the structure of the document 10 to configure a plurality of section chunks, and further chunking each section chunk whose size exceeds a preset threshold based on sentence similarity.

For example, the service server 100 may chunk the document 10 based on sentences including a section delimiter. The section delimiter may be, for example, a numeral, a parenthesized numeral, a Roman numeral, a circled numeral, or a special character in various forms.

The service server 100 may determine at least one of a plurality of section candidates as the section delimiter by using feature information of the plurality of section candidates, set in advance in various forms of numerals and/or characters such as a numeral, a parenthesized numeral, a Roman numeral, a circled numeral, or a special character.

The feature information may include the number of section candidates included in the document 10, the order in which the section candidates are identified from the document 10, and the text size of the sentence in which each of the section candidates is included.

The service server 100 may identify the section candidates in the document 10 and acquire the feature information of the section candidates by traversing the document 10 in a certain direction (e.g., in a rightward or downward direction within the document 10 from the location of a first sentence to a subsequent sentence).

For reference, in the present disclosure, the sentences included in the document 10 may refer to text-type data that includes characters, numerals, special characters, and the like, and are each distinguishable based on punctuation and/or newline characters.

The service server 100 may configure a semantic chunk in context by comparing similarities between sentences in an accumulative manner. For example, the service server 100 may chunk a section chunk configured according to some embodiments of the present disclosure into a plurality of sub-chunks based on the similarity between the sentences included in the section chunk.

Here, the service server 100 may determine whether to merge a sub-chunk and a sentence following the sub-chunk based on the similarity between a plurality of sentences (or accumulated sentences) forming the sub-chunk and the sentence located adjacent to the accumulated sentences, rather than based on the similarity between two adjacent individual sentences.

The service server 100 may determine a threshold for sentence similarity, which serves as a basis for chunking a section chunk, through vector similarity analysis between the document 10 and multiple queries generated from the document 10 using a generative model.

In the present disclosure, the generative model may refer to an artificial intelligence (AI)-based model trained on various types of text to generate responses to input queries.

In addition, the generative model may also be referred to as a large language model (LLM), a generative AI model, a question-answering model, a conversational model, or the like, depending on its implementation and/or operation.

For example, the service server 100 may input all or part of the document 10 to the generative model, generate query-response pairs corresponding to all or part of the document 10 using information output from the generative model, and determine the threshold for sentence similarity using a similarity distribution of a query for a document set that may be configured from all or part of the document 10.

The service server 100 may chunk the document 10 based on the format of data included in the document 10. To chunk the document 10 that includes text-type data and table-type data, the service server 100 may identify the table-type data included in the document 10 and configure the text- and/or table-type data as different chunks.

For example, the service server 100 may configure a table chunk including a table, identify sentences located adjacent to the table, and merge each identified sentence with high similarity with the table with the table chunk.

The service server 100 may train the chunking model 200 using the document 10 chunked according to some embodiments of the present disclosure.

The chunking model 200 may refer to a model trained to receive an input document as input and to output chunks configured by chunking the input document.

For example, the chunking model 200 may be trained using chunks of the document configured in consideration of the structure and/or context of the document 10 according to some embodiments of the present disclosure.

According to some embodiments of the present disclosure, the service server 100 may chunk the document 10 using the chunking model 200 that has been previously trained to output chunks of an input document. For example, the service server 100 may input the document 10 to the chunking model 200 and configure chunks of the document 10 using information output from the chunking model 200.

The service server 100 may index embedding vectors corresponding to the chunks of the document 10, configured according to some embodiments of the present disclosure, and store the indexed embedding vectors in the database 300.

The service server 100 may perform operations for chunking the document 10 according to embodiments of the present disclosure by using one or more models included in the database 300.

In one example, the service server 100 may determine a threshold for sentence similarity using the generative model.

In another example, the service server 100 may generate the embedding vectors corresponding to the chunks of the document 10 using an embedding model.

In yet another example, the service server 100 may configure the chunks of the document 10 using the chunking model 200.

The service server 100 may be implemented on at least one computing device. In one example, all functions of the service server 100 may be implemented on a single computing device. In another example, some functions of the service server 100 may be implemented on a first computing device, and the remaining functions may be implemented on a second computing device. Additionally, specific functions of the service server 100 may be implemented on one or more computing devices.

The database 300 may refer to a storage in which various data and/or information usable by the service server 100 according to some embodiments of the present disclosure is stored.

For example, the database 300 may include a model database including models usable by the service server 100 according to some embodiments of the present disclosure, and a vector database including the chunks generated by chunking the document 10 according to some embodiments of the present disclosure.

For example, the database 300 may include an embedding model trained to output embedding vectors corresponding to chunks including text and/or tables, a generative model trained to output query-response pairs from an input document, and the chunking model 200 trained to chunk an input document in consideration of the structure and/or context of the input document and to output chunks of the input document.

The components illustrated in FIG. 1 may communicate via various types of wired or wireless networks. Apparatuses and/or systems according to the present disclosure may be applied to a Local Area Network (LAN), a Wide Area Network (WAN), a mobile radio communication network, Wireless Broadband Internet (WiBro), and the like, and may also be applied to any other communication system without limitation.

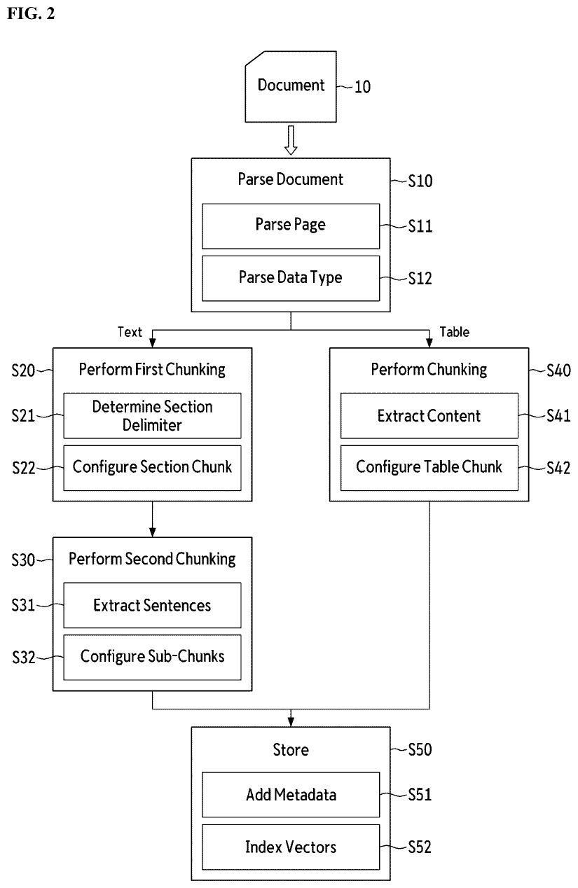

FIG. 2 illustrates a flow of operations of a chunking system according to some embodiments of the present disclosure.

Referring to FIG. 2, a service server 100 included in the chunking system according to some embodiments of the present disclosure may perform steps S20 and S30 to parse a document 10 and configure chunks of the document 10 that include text-type data, and perform step S40 to configure chunks of the document 10 that include table-type data. Thereafter, the service server 100 may store the chunks of the document 10 configured by performing steps S20, S30, and S40 in a vector database (S50).

A document parsing step (S10) may include a page parsing step (S11) and/or a data type parsing step (S12).

The document 10 may consist of one or more pages.

In step S11, pages forming the document 10 may be parsed, and the document 10 may be chunked by performing a chunking method according to some embodiments of the present disclosure on each of the parsed pages.

For example, when the document 10 consists of a plurality of pages, in step S11, the service server 100 may parse the plurality of pages forming the document 10 and perform chunking on each of the parsed pages, thereby configuring chunks corresponding to the respective pages.

In describing embodiments of the present disclosure, it is to be assumed that the document 10 consists of a single page.

However, this is merely for the convenience of explanation and is not intended to be limiting. For example, according to some embodiments of the present disclosure, the document may consist of a plurality of pages, and the service server 100 may configure chunks corresponding to the respective pages of the document 10 by performing steps S12, S20, S30, and S40 on each of the pages of the document 10.

In step S12, the service server 100 may parse the format of data included in the document 10. For example, in step S12, text-type data including characters, numerals, special characters, and/or the like may be identified from the document 10.

In another example, in step S12, table-type data consisting of one or more rows and/or columns that cannot be separated based on punctuation and/or newline characters may be identified from the document 10.

Referring to FIG. 2, the service server 100 may perform two-stage chunking (S20, S30) to chunk the text-type data included in the document 10.

A first chunking step (S20) may include a section delimiter determination step (S21) and/or a section chunk configuration step (S22).

In step S21, a section delimiter may refer to text data that serves as a basis for chunking the document 10 based on the structure of the document 10.

For example, the section delimiter may be in various forms of numerals and/or characters, such as a numeral, a parenthesized numeral, a Roman numeral, a circled numeral, or a special character.

In step S21, the service server 100 may determine the section delimiter from among a plurality of section candidates based on the features of the plurality of section candidates. At least one of the plurality of section candidates may be determined as the section delimiter.

The section candidates may be set in advance in various forms of numerals and/or characters, such as a numeral, a parenthesized numeral, a Roman numeral, a circled numeral, or a special character.

In step S22, the service server 100 may configure a section chunk by chunking the document 10 using the section delimiter determined in step S21.

A second chunking step (S30) may be performed on the section chunk configured in step S20.

When the size of the section chunk configured in step S20 exceeds a preset threshold, the second chunking step (S30) may be performed on the section chunk.

For reference, in the present disclosure, the size of a chunk may be calculated based on the size of data included in the chunk, the length of an embedding vector corresponding to the chunk, or the like.

The second chunking step (S30) may include a sentence extraction step (S31) and/or a sub-chunk configuration step (S32).

In step S31, sentences included in the section chunk may be extracted. For example, in step S31, the service server 100 may extract a plurality of sentences by distinguishing a plurality of pieces of text that are sequentially arranged based on preset punctuation and/or newline characters.

In step S32, the service server 100 may configure a sub-chunk by chunking the section chunk based on a similarity between the sentences included in the section chunk.

In step S32, to configure a chunk from sentences whose similarity is greater than or equal to a preset threshold, the service server 100 may calculate the similarity between the sub-chunk and a single sentence, and may merge the single sentence with the sub-chunk if the calculated similarity is greater than or equal to the preset threshold.

In other words, the section chunk may be chunked in an accumulative manner by calculating the similarity between the sentences accumulated/included in the sub-chunk and a single sentence, rather than the similarity between two individual sentences.

According to some embodiments of the present disclosure, a semantic sub-chunk in terms of context may be configured by calculating the similarity between sentences in an accumulative manner, rather than the similarity between individual sentences.

In step S32, the similarity between sentences may refer to the similarity between embedding vectors. For example, in step S32, to calculate the similarity between sentences, an embedding model may be invoked. In step S32, the service server 100 may input a single sentence and/or accumulated sentences included in the section chunk into the embedding model, generate embedding vectors corresponding to the input single sentence and/or accumulated sentences using information output from the embedding model, and compare the similarity between the generated embedding vectors.

For example, in the present disclosure, the similarity between embedding vectors may refer to cosine similarity, Euclidean distance, or the like, and is not particularly limited.

In addition, according to some embodiments of the present disclosure, to chunk the document 10, the first chunking step (S20), which considers the structure of the document 10, and the second chunking step (S30), which considers context for a section chunk whose size exceeds a threshold, may be performed in combination, thereby reducing the frequency of invoking the embedding model and decreasing the total processing time for chunking the document 10, compared to a case where chunking is performed solely based on the similarity between sentences.

Referring to FIG. 2, the service server 100 may perform a chunking step (S40) that includes a content extraction step (S41) and/or a table chunk configuration step (S42), to configure a table chunk including a table.

In step S41, the service server 100 may extract content adjacent to a table by identifying sentences in a certain direction from the table within the document 10 (e.g., leftward, upward, rightward, or downward from the location of the table).

A content extraction criterion such as a double newline, punctuation, or the like may be set in advance, and the service server 100 may identify sentences by traversing the document in a certain direction from the table until the content extraction criterion is met. The content extracted in step S41 may refer to one or more identified sentences.

The content adjacent to the table may include one or more sentences, and the service server 100 may configure a table chunk using the similarity between the table and the sentences included in the extracted content.

For example, in step S42, the service server 100 may configure a table chunk including the table, calculate the similarity between the table and the extracted content and/or the sentences included in the extracted content. Then, if the calculated similarity is greater than or equal to a preset threshold, the service server 100 may merge the table chunk with the extracted content and/or the sentences included in the extracted content, thereby configuring the table chunk updated to include the extracted content and/or the sentences.

For example, the service server 100 may parse Hypertext Markup Language (HTML) tags of the table, convert the parsed data of the table into a text-based markdown format, and calculate a similarity by comparing the converted data of the table with the extracted content and/or the sentences included in the extracted content.

The similarity between the table and the extracted content and/or the sentences included in the extracted content may refer to the similarity between embedding vectors.

For example, the service server 100 may input the table, the extracted content, and/or the sentences included in the extracted content, converted into text format, into the embedding model, generate embedding vectors corresponding to the table, the extracted content, and/or the sentences included in the extracted content, using information output from the embedding model, and calculate the similarity between the generated embedding vectors.

A storing step (S50) may include a metadata addition step (S51) and/or a vector indexing step (S52).

In step S51, the service server 100 may add metadata corresponding to each of the chunks of the document 10 configured through steps S10 through S40, and in step S52, index the embedding vectors corresponding to the respective chunks, generated using the embedding model, and store the indexed embedding vectors in the vector database.

The metadata may include a page number of the document 10 in which each chunk is included and a chunk number for identifying the corresponding chunk from other chunks.

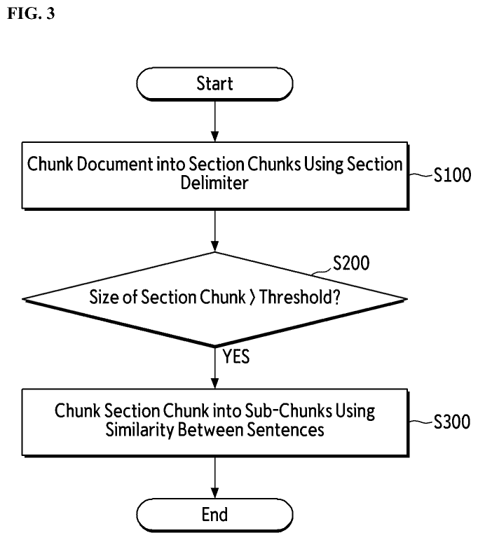

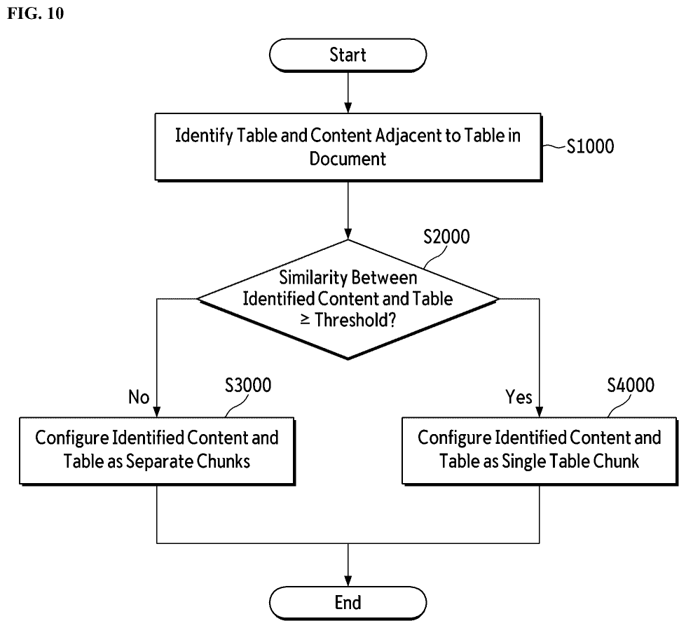

Embodiments in which a computing device performs chunking on the document 10 will hereinafter be described in detail with reference to FIGS. 3 through 12. FIGS. 3 through 6, FIG. 8, and/or FIG. 10 illustrate steps or operations performed by the service server 100 of FIG. 1. Accordingly, in the following description, when a subject performing a specific step or operation is omitted, the corresponding step or operation may be understood as being performed by the service server 100 of FIG. 1. The following description is made with reference to FIGS. 1 and 2 in conjunction with FIGS. 3 through 12.

It is also to be noted that the technical ideas understood from the embodiments described with reference to FIGS. 1 and 2 may obviously be applied to methods according to embodiments to be described with reference to FIGS. 3 to 12, even if not explicitly mentioned.

FIG. 3 is a flowchart illustrating an exemplary method for chunking the document including a plurality of sentences according to an embodiment of the present disclosure.

Steps S100, S200, and S300 in FIG. 3 may correspond to steps S20 and S30 in FIG. 2.

Referring to FIG. 3, a document 10 including a plurality of sentences may be chunked into a plurality of section chunks based on sentences including a section delimiter (S100).

The plurality of sentences included in the document 10 may be sequentially identified by traversing the document 10 in a direction from a first sentence to a sentence that follows the first sentence.

For example, in step S100, when one sentence including a section delimiter is identified, one or more sentences identified up to that point may be configured as a first section chunk. Also, the sentence including the section delimiter and one or more subsequent sentences identified until another sentence including a section delimiter is detected may be configured as a second section chunk.

It may be determined whether each of the plurality of section chunks configured in step S100 exceeds a preset first threshold (S200), and among the plurality of section chunks, a section chunk whose size exceeds the first threshold may be chunked into a plurality of sub-chunks based on a similarity between the sentences included in the section chunk (S300).

Specifically, in step S300, the section chunk whose size exceeds the first threshold may be chunked into a plurality of sub-chunks based on whether the similarity between the sentences included in the section chunk is greater than or equal to a preset second threshold.

The second threshold, which serves as a basis for chunking a section chunk in step S300, may be determined based on a similarity distribution of a query for the document 10, calculated by comparing queries, which are generated from the document 10 using a generative model, with the document 10.

Steps S100, S200, and S300 of FIG. 3 may correspond to the first and second chunking steps S20 and S30 of FIG. 2.

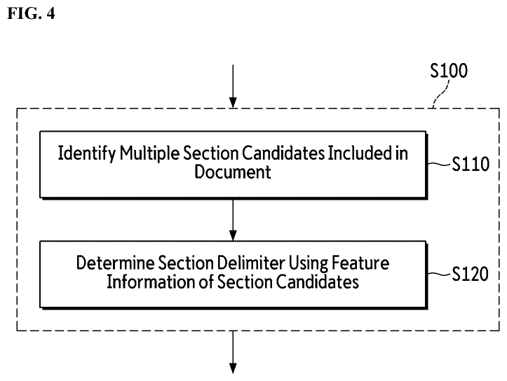

Embodiments for determining the second threshold for the similarity between sentences, which serves as a basis for whether to perform the second chunking step (S30) in step S300 of FIG. 3, will hereinafter be described in detail with reference to FIG. 4.

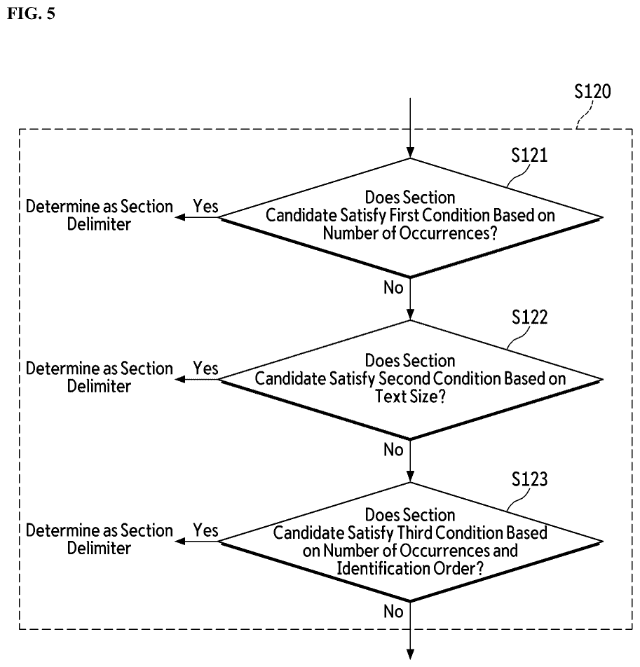

FIGS. 4 and 5 are flowcharts illustrating an exemplary method for chunking a document based on the structure of the document according to some embodiments of the present disclosure.

Step S100 in FIG. 4 may correspond to step S100 in FIG. 3.

Referring to FIG. 4, in step S100, a plurality of section candidates included in the document 10 may be identified by traversing the document 10 in a certain direction (S110).

In step S100, for example, the document 10 may be traversed in a rightward or downward direction from the location of the first sentence to the location of the sentence following the first sentence, and feature information of each of the plurality of section candidates may be acquired.

The feature information may include the number of occurrences of each section candidate identified from the document 10, the identification order of each section candidate in the document 10, and the text size of the sentence including each section candidate.

The plurality of section candidates may be set in advance in one of various forms of numerals and/or characters such as a numeral, a parenthesized numeral, a Roman numeral, a circled numeral, or a special character.

For example, some numerals or special characters (excluding, for example, the special character X) may be set in advance as the plurality of section candidates.

Some or all of the plurality of section candidates may be determined as the section delimiter in step S120 by using at least one of the number of occurrences of each section candidate in the document 10, the order in which the corresponding section candidate is identified, and the text size of the sentence including the corresponding section candidate.

In one example, a section candidate that satisfies a second condition, i.e., a section candidate with the smallest number of occurrences in the document 10, among the plurality of section candidates, may be determined as the section delimiter.

In another example, a section candidate that satisfies a first condition, i.e., a section candidate with the smallest text size of the sentence including the section candidate compared to other sentences in the document 10, may be determined as the section delimiter.

In yet another example, a section candidate that satisfies a third condition, i.e., a section candidate having fewer occurrences in the document 10 and resulting in a greater maximum chunk size than other section candidates when used to chunk the document 10, may be determined as the section delimiter. For example, if the number of occurrences of a section candidate identified from the document 10 is smaller than the number of occurrences of another section candidate identified from the document 10, and the size of a chunk, which is the largest among chunks that are configured when the document 10 is chunked based on sentences including the section candidate, is larger than the size of a chunk, which is the largest among chunks that are configured when the document 10 is chunked based on sentences including the another section candidate, the section candidate may be determined as the section delimiter.

In still another example, the first condition, the second condition, and/or the third condition for determining the section delimiter may be combined.

Embodiments for determining some of the plurality of section candidates as a section delimiter based on whether the first, second, or third condition is satisfied will hereinafter be described in detail with reference to FIG. 5.

Step S120 of FIG. 5 may correspond to step S120 of FIG. 4.

Referring to FIG. 5, a section candidate with the smallest number of occurrences in the document 10 among the plurality of section candidates may be determined as a section delimiter (S121).

Among the remaining section candidates not determined as section delimiters in step S121, a section candidate that satisfies the second condition may be determined as a section delimiter (S122). Specifically, in step S122, among the section candidates that have not been determined as section delimiters, a section candidate that is included in the sentence having the largest text size compared to other sentences in the document 10 may be determined as a section delimiter.

Among the remaining section candidates not determined as section delimiters in steps S121 and S122, a section candidate that satisfies the third condition may be determined as a section delimiter (S123). In step S123, among the remaining section candidates that have not been determined as section delimiters, a section candidate whose number of occurrences in the document 10 is smaller than that of another section candidate, and which results in a greater maximum chunk size than another section candidate when used to chunk the document 10 may be determined as a section delimiter.

That is, in step S123, even a section candidate with fewer occurrences in the document 10 than other section candidate among the remaining section candidates may not be determined as a section delimiter if it results in a smaller maximum chunk size than another remaining section candidate when used to chunk the document 10.

As illustrated in FIG. 5, the first condition, second condition, and third condition may be prioritized in that order, but the present disclosure is not limited thereto.

In addition, the third condition may further include a condition based on the order in which each section candidate is identified in the document 10.

In one example, even if one section candidate has fewer occurrences in the document 10 and results in a greater maximum chunk size than other section candidates, the section candidate may not be determined as a section delimiter, if the section candidate is identified later than the other candidates.

In another example, when there are two section candidates among the plurality of section candidates having the same size in the document 10 and having the maximum chunk size, one of the two section candidates identified earlier than the other may be determined as a section delimiter.

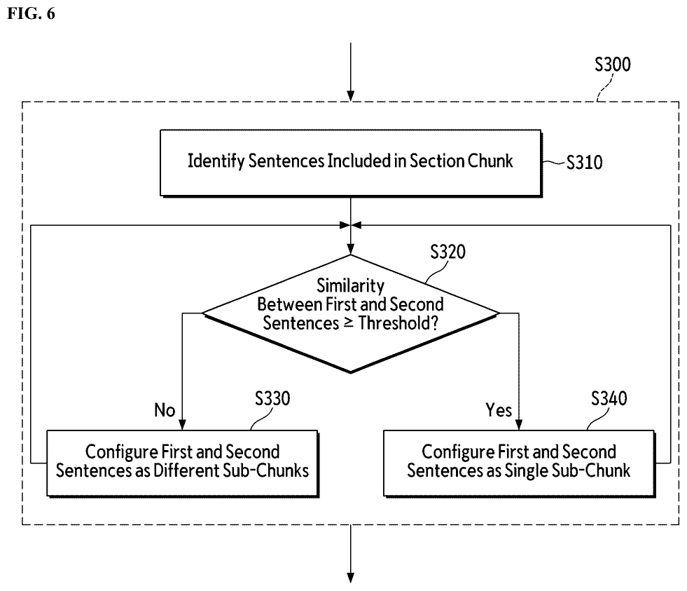

Embodiments for chunking a section chunk based on the similarity between sentences in step S300 of FIG. 3 will hereinafter be described in detail with reference to FIG. 6.

FIG. 6 is a flowchart illustrating an exemplary method for chunking a document in consideration of context by comparing similarities between sentences in an accumulative manner according to some embodiments of the present disclosure.

Step S300 in FIG. 6 may correspond to step S300 in FIG. 3.

Referring to FIG. 6, in step S300, a plurality of sentences included in a section chunk may be identified (S310).

In step S310, the sentences included in the section chunk may be sequentially identified by traversing the section chunk 10 in a certain direction (e.g., a rightward or downward direction within the document 10 from the location of a first sentence in the section chunk to the location of a second sentence following the first sentence within the section chunk).

The similarity between the first and second sentences may be calculated, and it may be determined whether the calculated similarity is greater than or equal to a preset threshold (S320).

In step S320, each of the sentences included in the section chunk may be input into an embedding model, and an embedding vector corresponding to each of the sentences may be generated using information output from the embedding model, such that the similarity between the sentences may be calculated as an embedding vector similarity.

If the similarity between the first and second sentences is less than the preset threshold, the first and second sentences may be configured as different sub-chunks (S330).

Conversely, if the similarity between the first and second sentences is greater than or equal to the preset threshold, the first and second sentences may be configured as a single sub-chunk (S340).

Steps S320 through S340 may be repeatedly performed for all of the sentences included in the section chunk, thereby chunking the section chunk.

However, in repeatedly performing steps S320, S330, and S340, similarities may be compared in an accumulative manner between the sentences accumulated/included in each sub-chunk and a sentence arranged/identified in subsequent order to the corresponding sub-chunk, rather than between two sequentially identified individual sentences.

For example, the similarity between the sub-chunk including the second sentence, configured in steps S320, S330, and S340, and a third sentence following the second sentence may be calculated. If the calculated similarity is greater than or equal to a preset threshold, the third sentence may be merged with the sub-chunk including the second sentence, thereby configuring the second and third sentences as a single sub-chunk. If the calculated similarity is less than the preset threshold, a new sub-chunk including the third sentence may be configured, thereby configuring the third sentence and the sub-chunk including the second sentence as different sub-chunks.

In step S300, if the size of a sub-chunk configured by chunking the section chunk exceeds a preset maximum chunk size, the size of the configured sub-chunk may be adjusted using a text rank algorithm.

The text rank algorithm may refer to an algorithm that extracts text data with high importance within a sub-chunk by calculating the importance of text data included in the sub-chunk and updating the importance based on the similarity of the text data with other text data.

For example, in step S340, if the size of a sub-chunk configured by merging a sentence with a sub-chunk including a preceding sentence exceeds the preset maximum chunk size, one or more keywords may be extracted from the sub-chunk using the text rank algorithm. Then, based on the distribution of the keywords within the sub-chunk, the sub-chunk may be split based on a sentence that does not include the keywords and/or a sentence in which the keywords are densely or sparsely distributed, such that the sub-chunk may be re-chunked into a plurality of sub-chunks.

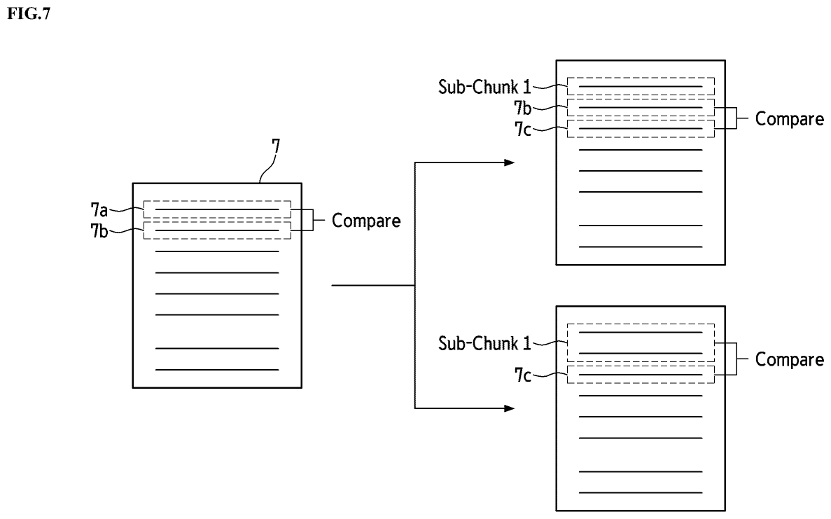

FIG. 7 is a diagram for explaining a process of constructing a sub-chunk in an accumulative manner according to some embodiments of the present disclosure.

Referring to FIG. 7 together with FIG. 6, a similarity between a first sentence 7a and a second sentence 7b that are included in a sub-chunk 7 and arranged in sequential order may be calculated as an embedding vector similarity.

If the embedding vector similarity between the first and second sentences 7a and 7b is less than a preset threshold, the first and second sentences 7a and 7b may be configured as different sub-chunks. It may then be determined whether to merge a third sentence 7c that is following the second sentence 7b with the sub-chunk including the second sentence 7b based on the embedding vector similarity between the third sentence 7c and the second sentence 7b and/or the sub-chunk including the second sentence 7b.

If the similarity between the first and second sentences 7a and 7b is greater than or equal to the preset threshold, the first and second sentences 7a and 7b may be configured as a single sub-chunk. Then, a determination may be made as to whether to merge the third sentence 7c, which is arranged in subsequent order to the second sentence 7b, with the sub-chunk including the first and second sentences 7a and 7b, i.e., with the combination of the first and second sentences 7a and 7b, based on the embedding vector similarity between the third sentence 7c and the sub-chunk including the first and second sentences 7a and 7b.

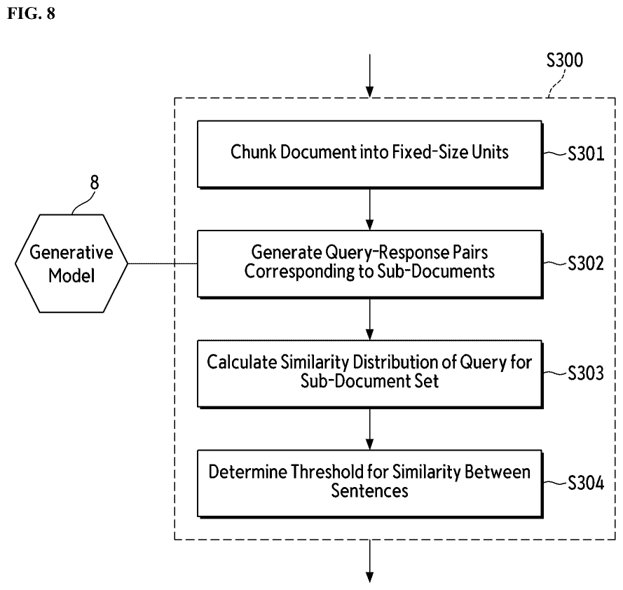

Embodiments for determining a threshold for the similarity between sentences in step S300 of FIG. 3 will hereinafter be described in detail with reference to FIG. 8.

FIG. 8 is a flowchart illustrating an exemplary method for determining a threshold for the similarity between sentences according to some embodiments of the present disclosure.

Step S300 in FIG. 8 may correspond to step S300 in FIG. 3 and/or FIG. 6.

Referring to FIG. 8, in step S300, the document 10 may be chunked in preset-size units, thereby configuring a plurality of sub-documents having a fixed size (S301).

Each of the plurality of sub-documents may be input into a generative model 8, and a query-response pair may be generated from each of the plurality of sub-documents using information output from the generative model 8 (S302).

For example, in step S302, a prompt including a sub-document and an output format for a query and/or response may be input into the generative model 8, and a query generated from the sub-document and a response to the generated query may be output according to the input format.

For each of the plurality of sub-documents, a similarity distribution of a query for a sub-document set consisting of combinations of the sub-document corresponding to the query and/or other sub-documents may be calculated (S303), and based on the calculated similarity distribution, a threshold for the similarity between sentences, which serves as a basis for chunking a section chunk in step S300 of FIG. 3, may be determined (S304).

In step S303, the similarity distribution of the query for the sub-document set may refer to an embedding vector similarity distribution, and may be calculated by computing the cosine similarity between an embedding vector of the query and embedding vectors of the combinations of the corresponding sub-document and/or other sub-documents included in the sub-document set, which are generated using an embedding model.

For example, in step S301, the document 10 may be chunked in preset-size units, thereby configuring a first sub-document, a second sub-document, and a third sub-document. In step S302, a query and a response to the query may be generated from each of the first, second, and third sub-documents using the generative model 8. Step S303 may be performed for each of the plurality of sub-documents.

For example, in step S303, a first embedding vector similarity distribution of a first query corresponding to the first sub-document for a first sub-document set may be calculated, and a second embedding vector similarity distribution of the first query for a second sub-document set may be calculated.

Here, the first sub-document set may refer to a set of combinations of sub-documents that include the first sub-document, among all possible combinations of the plurality of sub-documents having a fixed size.

In addition, the second sub-document set may refer to a set of all possible combinations of the plurality of sub-documents having a fixed size, excluding the first sub-document.

The threshold for the similarity between sentences, which serves as a basis for chunking a section chunk in step S300 of FIG. 3, may be determined based on deviations between first embedding vector similarity distributions of the queries for the plurality of sub-documents (i.e., first embedding vector similarity distributions of the queries calculated for the respective sub-documents) and second embedding vector similarity distributions of the queries for the plurality of sub-documents (i.e., second embedding vector similarity distributions of the queries calculated for the respective sub-documents).

For example, when the document 10 is denoted as D, a set of sub-documents of D as {dᵢ}, a query corresponding to a sub-document dᵢ, generated using the generative model 8 as qᵢ, a set of combinations of all the sub-documents in the set {dᵢ} except for the sub-document dᵢ as {dᵢ′}, and a set of combinations that include the sub-document dᵢ, among all combinations of the sub-documents in the set {dᵢ}, as {dⱼ′} (j≠i). Then, in step S303, a first embedding vector similarity distribution sim(qᵢ, {dⱼ′}) between the query qᵢ and the set {dᵢ′} and a second embedding vector similarity distribution sim(qᵢ, {dᵢ′}) between the query qᵢ and the set {dᵢ′} may be calculated.

A threshold sim threshold for the similarity between sentences, which serves as a basis for chunking a section chunk in step S300 of FIG. 3, may be calculated based on the deviation between the minimum value of the first embedding vector similarity distribution sim(qᵢ, {dⱼ′}) and the maximum value of the second embedding vector similarity distribution sim(qᵢ, {dᵢ′}).

For example, the threshold sim threshold may be determined as a midpoint value between a first embedding vector similarity distribution minimum min (sim(qᵢ, {dⱼ′})|i∈1) for the sub-document dᵢ (where 1 denotes a set of indices i for the sub-document dᵢ) and a second embedding vector similarity distribution maximum max (sim(qᵢ, {dᵢ′})|i∈1) for the sub-document dᵢ, as indicated by the following equation:

$$sim threshold = min ( sim ( {q}_{i} , \{ {d}_{j}^{′} \} ) \vert i ∈ I ) + \frac{max ( sim ( {q}_{i} , \{ {d}_{j}^{′} \} ) \vert i ∈ I ) - min ( sim ( {q}_{i} , \{ {d}_{j}^{′} \} ) \vert i ∈ I )}{2} .$$

The document 10 that has been chunked in units of chunks (i.e., in section chunks and/or sub-chunks) according to the embodiments described with reference to FIGS. 3 through 8 may be used as training data for the chunking model 200.

For example, according to some embodiments of the present disclosure, sentences at split points of the document 10 that is divided into chunks may be labeled with 1, and sentences at non-split points of the document 10 may be labeled with 0, and the chunking model 10 may be trained using the chunks of the document 10, such that the chunking model 200 may learn the splitting pattern of the document 10 through these binary labels.

Here, the split points of the document 10 may refer to a first sentence among sentences sequentially included in each section chunk and/or sub-chunk of the document 10 configured according to some embodiments of the present disclosure, and the non-split points of the document 10 may refer to the other sentences in the corresponding section chunk and/or the sub-chunk of the document 10.

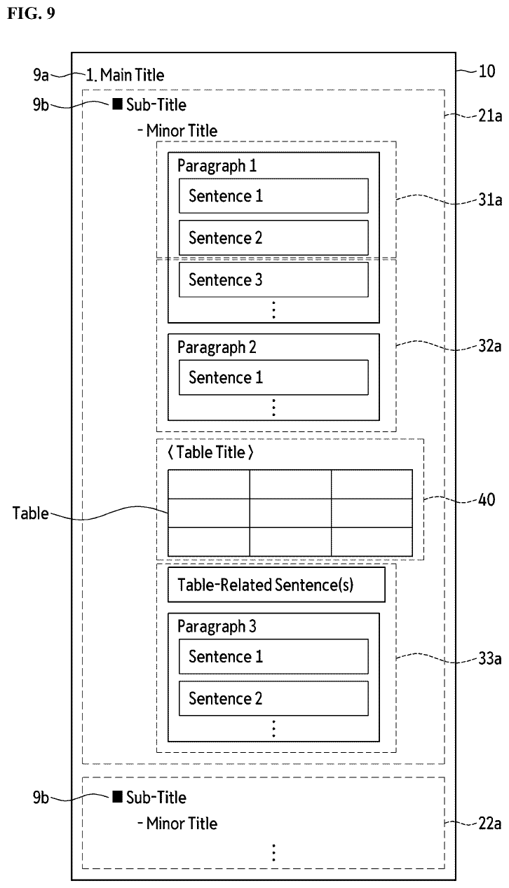

FIG. 9 illustrates exemplary chunks configured by chunking text-type data included in the document 10 according to some embodiments of the present disclosure.

Referring to FIG. 9, according to some embodiments of the present disclosure, when a numeral 9a for separating a main title and a special character 9b for separating a sub-title are determined as section delimiters, the document 10 may be chunked by being divided into a first section chunk 21a and a second section chunk 22a based on sentences including the section delimiters 9a and 9b, respectively.

Additionally, sentences included in the first section chunk 21a and/or the second section chunk 22a may be further divided based on the similarity between sentences calculated in an accumulative manner, and sub-chunks of each of the first and second section chunks 21a and 22a may be configured accordingly.

For example, as illustrated in FIG. 9, the first section chunk 21a may include a table and a plurality of sentences, and may be chunked into a first sub-chunk 31a, a second sub-chunk 32a, and a third sub-chunk 33a.

A table included in the document 10 may be configured as a separate table chunk 40, apart from the section chunks and/or the sub-chunks configured according to some embodiments of the present disclosure.

In addition, although not illustrated in FIG. 9, as described earlier with regard to step S40 in FIG. 2, even a sentence included in a section chunk and/or a sub-chunk may be merged with the table chunk 40 if its similarity with the table included in the table chunk 40 is greater than or equal to a preset threshold.

According to some embodiments of the present disclosure, a document may be chunked based on the similarity between sentences calculated in an accumulative manner, regardless of paragraphs separated by newline characters. As a result, chunks may be configured based on the structure of a document and/or the similarity between sentences, which may reduce the likelihood of each chunk being split in the middle of a sentence or of sentences with low similarity being merged into the same chunk, unlike when the document is simply chunked into fixed-size chunks.

Accordingly, when a chunk related to a specific query is retrieved from a document chunked in units of chunks, the accuracy of the retrieved chunk may be improved, and the accuracy of a response to the query generated using the retrieved chunk may be enhanced.

FIG. 10 is a flowchart illustrating an exemplary method for chunking a document 10 including a table according to an embodiment of the present disclosure.

Steps S1000, S2000, S3000, and S4000 in FIG. 10 may correspond to step S40 in FIG. 2.

Referring to FIG. 10, in step S1000, by traversing the document 10 in a certain direction from a table included in the document 10, content adjacent to the table may be identified.

Here, the content may refer to one or more sentences included in the document 10, which are identified by traversing the document 10 in the certain direction from the table.

The document 10 may include sequentially arranged sentences and/or tables. For example, in step S1000, by traversing the document 10 in a leftward, upward, rightward, or downward direction from a table, content, which contains sentences arranged in sequential order before or after the table, may be identified.

In step S1000, one or more sentences may be identified by traversing the document in the certain direction from the table until a preset content extraction condition is satisfied.

In one example, the content extraction condition may be set in advance such that sentences arranged before a double newline character is detected may be identified as the content. In this example, in step S1000, one or more sentences included in a paragraph arranged in the leftward, upward, rightward, or downward direction from the table may be identified as the content.

In another example, the content extraction condition may be set in advance such that sentences arranged before N punctuation marks and/or newline characters are detected (where N is an arbitrary natural number) are identified as the content. In this example, in step S1000, N sentences arranged in the leftward, upward, rightward, or downward direction from the table may be identified as the content.

In yet another example, the content extraction condition may be set in advance such that a single sentence based on a punctuation mark and/or newline character is identified as the content, and a table chunk 40 may be configured by repeatedly performing steps S1000 through S4000 until a sentence not to be merged with the table chunk 40 because of its similarity with the table included in the table chunk 40 being less than a preset threshold is identified.

In step S2000, the similarity between the table and the content may be calculated, and it may be determined whether the calculated similarity is greater than or equal to a preset threshold.

In step S2000, the similarity between the table and the content may refer to an embedding vector similarity.

For example, the HTML tags of the table may be parsed, and the parsed data of the table may be converted into a text-based markdown format.

In step S2000, the table and/or the content converted into text format may be input into an embedding vector model, and embedding vectors corresponding to the table and/or the content may be generated using information output from the embedding vector model. Then, the similarity between the table and the content may be calculated by computing the cosine similarity between the embedding vectors.

If the similarity between the content and the table is less than the preset threshold, the content may be configured as a chunk separate from the table (S3000).

Conversely, if the similarity between the table and the content is greater than or equal to the preset threshold, the content may be merged with the table chunk 40 including the table, such that the content and the table may be configured as a single table chunk (S4000).

Referring again to FIG. 2, chunks (e.g., section chunks and/or sub-chunks) including the sentences included in the document 10 may be configured according to the embodiments described with reference to FIGS. 3 through 8, and a table chunk 40 including the table included in the document 10 may be configured according to the embodiments described with reference to FIG. 10.

According to some embodiments of the present disclosure, even a sentence included in a section chunk and/or sub-chunk may be merged with the table chunk 40 if it is arranged adjacent to the table included in the table chunk 40 and identified as content in step S1000 of FIG. 10.

In one example, in step S3000, content not merged with the table chunk 40 may be included in a section chunk and/or sub-chunk configured according to the embodiments described with reference to FIGS. 3 through 8.

In another example, in step S4000, even content included in a section chunk and/or sub-chunk configured according to the embodiments described with reference to FIGS. 3 through 8 may be merged with the table chunk 40, in this case, the content may be separated from the corresponding section chunk and/or sub-chunk and may instead be included in the table chunk 40.

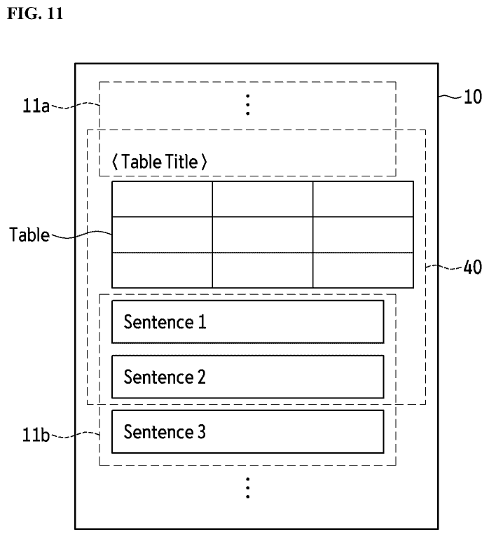

FIG. 11 is a diagram for explaining a process of configuring a table chunk 40 according to some embodiments of the present disclosure.

By traversing the document 10 based on a table included in the document 10, one or more sentences arranged above the table may be identified as first content 11a, and one or more sentences arranged below the table may be identified as second content 11b.

Referring to FIG. 11 together with FIG. 10, even a sentence identified as the first content 11a and/or the second content 11b may not be included in the table chunk 40 if its similarity with the table included in the table chunk 40 is less than a preset threshold.

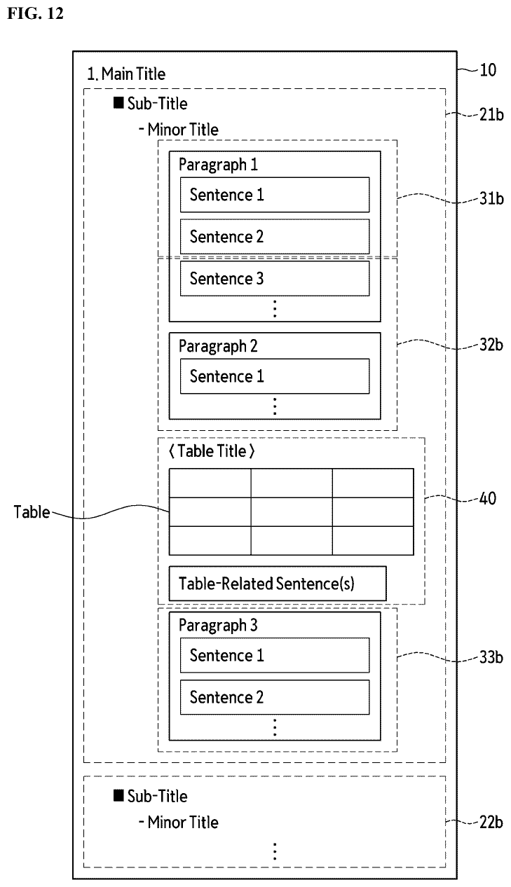

FIG. 12 illustrates an exemplary document chunked according to some embodiments of the present disclosure.

Specifically, FIG. 12 illustrates a reconfigured document 10 obtained by performing step S40 in FIG. 2 and/or steps S1000 through S4000 in FIG. 10 on the document 10 illustrated in FIG. 9.

A first section chunk 21b, a second section chunk 22b, a first sub-chunk 31b, and a second sub-chunk 32b in FIG. 12 may correspond to their respective counterparts of FIG. 9.

Referring to FIG. 12 together with FIG. 9, even a sentence configured as the third sub-chunk 33a in FIG. 9 according to some embodiments of the present disclosure may be merged with a table chunk 40 if it is related to the table included in the table chunk 40 and its similarity with the table included in the table chunk 40 is equal to or greater than a preset threshold. Accordingly, the sentence may be separated from the third sub-chunk 33a, and the third sub-chunk 33a may be reconfigured as a sub-chunk 33b that does not include a table-related sentence.

In addition, although not illustrated in FIG. 12, the document 10 may include a plurality of tables, and table chunks corresponding to the respective tables may be configured according to embodiments of the present disclosure.

According to some embodiments of the present disclosure, the document 10 may be chunked in consideration of the types of data included in the document 10 and the structure and context of the document 10. As a result, when a chunk related to a specific query is retrieved from the document 10 chunked in units of chunks, the accuracy of the retrieved chunk may be improved, and consequently, the accuracy of a response to a query generated using the retrieved chunk may also be enhanced.

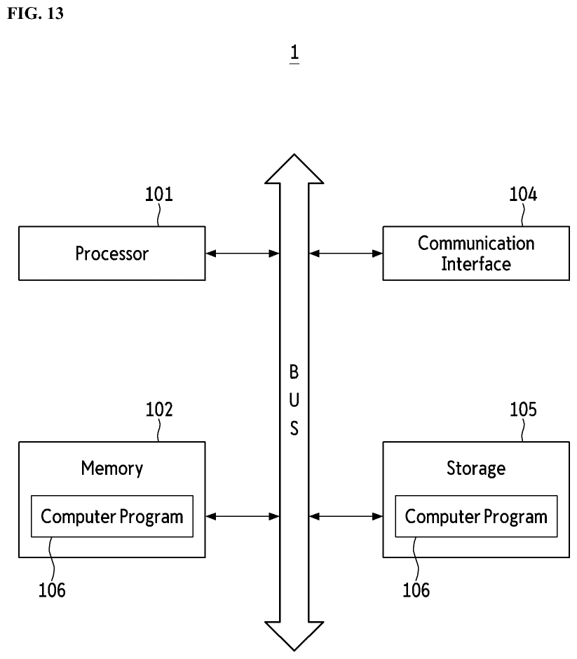

FIG. 13 is an illustrative hardware configuration diagram illustrating the computing device 1.

Referring to FIG. 13, the computing device 1 may include at least one processor 101, a system bus 103, a communication interface 104, a memory 102, which loads a computer program 106 executed by the processor 101, and a storage 105, which stores the computer program 106. Even though FIG. 13 depicts only components related to the embodiments of the present disclosure, it is obvious to one of ordinary skill in the art to which the present disclosure pertains that the computing device 1 may further include other generic components, in addition to the components depicted in FIG. 13. Moreover, in some embodiments, the computing device 1 may be configured with some of the components depicted in FIG. 13 omitted. The components of the computing device 1 will hereinafter be described.

The processor 101 may control the overall operation of each of the components of the computing device 1. The processor 101 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 101 may perform computations for at least one application or program to execute operations/methods according to some embodiments of the present disclosure. The computing device 1 may be equipped with one or more processors.

In Addition, the computing device 1 may further include database, and the processor 101 may store data and/or information generated/output according to some embodiments of the present disclosure in the memory 102 and/or a database. Here, the database in which the data and/or information is stored is not limited to the database included in the computing device 1, and may include, for example, a database of external server.

The memory 102 may store various data, commands, and/or information. The memory 102 may load the computer program 166 from the storage 105 to execute the operations/methods according to some embodiments of the present disclosure. The memory 102 may be implemented as a volatile memory such as a random-access memory (RAM), but the present disclosure is not limited thereto.

The bus 103 may provide communication functionality between the components of the computing device 1. The bus 103 may be implemented in various forms such as an address bus, a data bus, and a control bus.

The communication interface 104 may support wired or wireless Internet communication of the computing device 1. Additionally, the communication interface 104 may also support various other communication methods. To this end, the communication interface 104 may be configured to include a communication module well-known in the technical field of the present disclosure.

The storage 105 may non-transitorily store at least one computer program 106. The storage 105 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 106, when loaded into the memory 102, may include one or more instructions that enable the processor 101 to perform the operations/methods according to some embodiments of the present disclosure. That is, by executing the loaded one or more instructions, the processor 101 may perform the operations/methods according to some embodiments of the present disclosure.

In one example, the computer program 106 may include instructions for: chunking a document including a plurality of sentences into a plurality of section chunks based on sentences including a section delimiter; determining whether the size of each of the section chunks exceeds a preset first threshold; and when a size of a section chunk among the plurality of section chunks exceeds the first threshold, chunking the section chunk into a plurality of sub-chunks based on whether the similarity between sentences included in the section chunk is equal to or greater than a second threshold. Here, the second threshold may be determined based on a similarity distribution of a query for the document, calculated by comparing a query generated from the document using a generative model with the document.

In another example, the computer program 106 may include instructions for: identifying a plurality of sentences by traversing a document including a table in a certain direction from the table; and configuring a chunk including the table and one or more sentences among the plurality of identified sentences whose similarity with the table is equal to or greater than a preset first threshold.

In yet another example, the computer program 106 may include instructions for: inputting a document including a plurality of sentences into a pre-trained chunking model; configuring a plurality of different chunks each including a portion of the plurality of sentences using information output from the chunking model; and storing embedding vectors corresponding to the respective chunks. Here, the plurality of chunks may include a section chunk and a plurality of sub-chunks. The section chunk may be a first section chunk whose size is less than or equal to a preset first threshold among a plurality of section chunks configured by chunking the document based on sentences including a section delimiter among the plurality of sentences, and the plurality of sub-chunks may be configured by chunking a second section chunk whose size exceeds the preset first threshold among the plurality of section chunks, based on whether the similarity between sentences included in the second section chunk is equal to or greater than a preset second threshold. The second threshold may be determined based on a similarity distribution of a query for the document, calculated by comparing a query generated from the document using a generative model with the document.

Various embodiments of the present disclosure and their effects have been described so far with reference to FIGS. 1 through 13.

It should be noted that the effects of the present disclosure are not limited to those described above, and other effects of the present disclosure will be apparent from the following description.

The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for chunking a document, performed by a computing system, comprising:
chunking a document including a plurality of sentences into a plurality of section chunks based on sentences including a section delimiter;
determining whether a size of each of the plurality of section chunks exceeds a preset first threshold; and
when a size of a section chunk among the plurality of section chunks exceeds the preset first threshold, chunking the section chunk into a plurality of sub-chunks based on whether a similarity between sentences included in the section chunk is equal to or greater than a second threshold,
wherein the second threshold is determined based on a similarity distribution of a query for the document, calculated by comparing a query generated from the document using a generative model with the document.

2. The method of claim 1, wherein the chunking of the document into the plurality of section chunks comprises:
identifying a plurality of predefined section candidates included in the document by traversing the document in a certain direction; and
determining a portion of the plurality of predefined section candidates as the section delimiter using at least one of a number of occurrences of each of the plurality of predefined section candidates in the document, a text size of a sentence including each of the plurality of predefined section candidates, or an identification order of each of the plurality of predefined section candidates in the document.

3. The method of claim 2, wherein the determining of the portion of the plurality of predefined section candidates as the section delimiter comprises:
determining a section candidate with a smallest number of occurrences among the plurality of predefined section candidates as the section delimiter.

4. The method of claim 2, wherein the determining of the portion of the plurality of predefined section candidates as the section delimiter comprises:
determining a section candidate whose sentence has a largest text size among the plurality of sentences included in the document as the section delimiter.

5. The method of claim 2, wherein the determining of the portion of the plurality of predefined section candidates as the section delimiter comprises:
when a number of occurrences of a first section candidate is smaller than a number of occurrences of a second section candidate, and a size of a first chunk is greater than a size of a second chunk, determining the first section candidate as the section delimiter,
the first chunk is a largest chunk among chunks configured by chunking the document based on the first section candidate, and
the second chunk is a largest chunk among chunks configured by chunking the document based on the second section candidate.

6. The method of claim 5, wherein the first section candidate is not determined as the section delimiter when an identification order of the first section candidate is later than an identification order of the second section candidate.

7. The method of claim 1, wherein the chunking of the section chunk into the plurality of sub-chunks comprises:
when an embedding vector similarity between a first sentence and a second sentence included in the section chunk is equal to or greater than the second threshold, configuring a first sub-chunk including the first and second sentences;
when the embedding vector similarity between the first and second sentences is less than the second threshold, configuring a second sub-chunk including the first sentence and configuring a third sub-chunk that is different from the second sub-chunk and includes the second sentence;
when the embedding vector similarity between a sub-chunk including the second sentence and a third sentence is equal to or greater than the second threshold, configuring a fourth sub-chunk by merging a sub-chunk including the second sentence with the third sentence; and
when the embedding vector similarity between the sub-chunk including the second sentence and the third sentence is less than the second threshold, configuring a fifth sub-chunk that is different from the sub-chunk including the second sentence and includes the third sentence,
the second sentence is a sentence identified in subsequent order to the first sentence within the section chunk, and
the third sentence is a sentence identified in subsequent order to the second sentence within the section chunk.

8. The method of claim 7, wherein the configuring of the fourth sub-chunk comprises:
when a size of the fourth sub-chunk exceeds a preset third threshold, extracting a keyword from the fourth sub-chunk using a text rank algorithm; and
chunking the fourth sub-chunk into a plurality of sub-chunks using a distribution of the keyword within the fourth sub-chunk.

9. The method of claim 1, wherein
the chunking of the section chunk into the plurality of sub-chunks comprises:
configuring a plurality of sub-documents by chunking the document into preset fixed-size units;
inputting the plurality of sub-documents into the generative model and generating a plurality of query-response pairs respectively corresponding to the plurality of sub-documents using output of the generative model; and
for each of the plurality of sub-documents, calculating a first embedding vector similarity distribution of a first query for a first sub-document set, wherein the first query corresponds to a first sub-document, and the first sub-document set includes combinations of the plurality of sub-documents including the first sub-document, and calculating a second embedding vector similarity distribution of the first query for a second sub-document set, wherein the second sub-document set includes combinations of the plurality of sub-documents excluding the first sub-document, and
the second threshold is calculated using a deviation between a minimum value of the first embedding vector similarity distribution and a maximum value of the second embedding vector similarity distribution for the plurality of sub-documents.

10. The method of claim 1, further comprising:
training a chunking model using the document chunked in units of chunks,
wherein the chunking model is a model pre-trained to receive an input document and chunk the input document into a plurality of chunks.

11. A method for chunking a document, performed by a computing system, comprising:
identifying a plurality of sentences by traversing a document including a table in a certain direction from the table; and
configuring a chunk including the table and one or more sentences among the plurality of identified sentences whose similarity with the table is equal to or greater than a preset first threshold.

12. The method of claim 11, wherein the configuring of the chunk comprises:
configuring a plurality of chunks by chunking the document, the plurality of chunks including a first chunk including the table and a second chunk including the plurality of sentences; and
when a similarity between the table and a first sentence among the plurality of sentences is equal to or greater than the preset first threshold, merging the first sentence into the first chunk.

13. A method for chunking a document, performed by a computing system, comprising:
inputting a document including a plurality of sentences into a pre-trained chunking model;
configuring a plurality of different chunks each including a portion of the plurality of sentences using information output from the chunking model; and
storing embedding vectors corresponding to the respective chunks,
wherein the plurality of different chunks include a section chunk and a plurality of sub-chunks,
wherein the section chunk is a first section chunk whose size is less than or equal to a preset first threshold among a plurality of section chunks configured by chunking the document based on sentences including a section delimiter among the plurality of sentences,
wherein the plurality of sub-chunks are configured by chunking a second section chunk, whose size exceeds the preset first threshold among the plurality of section chunks, based on whether a similarity between sentences included in the second section chunk is equal to or greater than a preset second threshold, and
wherein the preset second threshold is determined based on a similarity distribution of a query for the document, calculated by comparing a query generated from the document using a generative model with the document.

14. A system for chunking a document, comprising:
at least one processor; and
at least one memory storing instructions which, when executed by the at least one processor, cause the at least one processor to perform operations,
wherein the operations comprise:
chunking a document including a plurality of sentences into a plurality of section chunks based on sentences including a section delimiter;
determining whether a size of each of the plurality of section chunks exceeds a preset first threshold; and
when a size of a section chunk among the plurality of section chunks exceeds the preset first threshold, chunking the section chunk into a plurality of sub-chunks based on whether a similarity between sentences included in the section chunk is equal to or greater than a second threshold,
wherein the second threshold is determined based on a similarity distribution of a query for the document, calculated by comparing a query generated from the document using a generative model with the document.

15. A system for chunking a document, comprising:
at least one processor; and
at least one memory storing instructions which, when executed by the at least one processor, cause the at least one processor to perform operations,
wherein the operations comprise:
identifying a plurality of sentences by traversing a document including a table in a certain direction from the table; and
configuring a chunk including the table and one or more sentences among the plurality of identified sentences whose similarity with the table is equal to or greater than a preset first threshold.
